(19) United States
(12) Patent Application Publication
(10) Pub. No.: US 2018/0024158 A1
(43) Pub. Date: Jan. 25, 2018

(54) TURBOCHARGER ROTATION DETECTOR

(71) Applicant: Hitachi Metals, Ltd., Tokyo (JP)

(72) Inventors: Yuta SUGIYAMA, Itabashi (JP); Takashi ONIMOTO, Hitachi (JP)

(21) Appl. No.: 15/641,695

(22) Filed: Jul. 5, 2017

(30) Foreign Application Priority Data
Jul. 21, 2016 (JP) 2016-143242

(51) Int. Cl. G01P 3/49; G01P 3/46

(52) U.S. Cl. CPC G01P 3/49; G01P 3/46

(57) ABSTRACT

A turbocharger rotation detector includes an oscillator circuit that includes a coil generating a magnetic field inducing an eddy current in blades of a compressor wheel and outputs as a detection signal an AC signal having an amplitude varying with approach and recession of the blades, a first detector circuit for detecting, of the detection signal, a signal component of a positive voltage higher than a reference potential, a second detector circuit for detecting, of the detection signal, a signal component of a negative voltage lower than the reference potential, a first interrupter circuit that, of an output signal of the first detector circuit, interrupts a DC component, a second interrupter circuit that, of an output signal of the second detector circuit, interrupts a DC component, and a differential amplifier circuit to which the signals passing through the first and second interrupter circuits are input.

The present application is based on Japanese patent application No. 2016-143242 filed on Jul. 21, 2016, the entire contents of which are incorporated herein by reference.

### BACKGROUND OF THE INVENTION

### 1. Field of the Invention

The invention relates to a turbocharger rotation detector for detecting a rotational speed of a compressor wheel of a turbocharger.

### 2. Description of the Related Art

A conventional turbo rotation sensor is known, in which an eddy-current sensor is used to detect a rotational speed of a turbocharger mounted on a vehicle (see, e.g. JP-B-5645207).

In the turbo rotation sensor disclosed by JP-B-5645207, a sensing portion of the eddy-current sensor is formed by winding a coil around a ferrite core. This turbo rotation sensor is inserted into a hole formed on a compressor housing which houses a compressor wheel, so that the sensing portion faces blades of the compressor wheel. When the compressor wheel rotates and the blade comes close to the sensing portion, an eddy-current is induced in the blade due to a magnetic field generated in the sensing portion and causes eddy-current loss. By counting variations in an electric signal (detection signal of the eddy-current sensor) due to the eddy-current loss, it is possible to detect a rotational speed of the turbocharger.

### SUMMARY OF THE INVENTION

The variation in the detection signal of the eddy-current sensor due to the eddy-current loss caused by approach of the blade of the compressor wheel to the sensing portion is very small. Thus, in order to precisely count the number of approaches of the blade to the sensing portion without misdetection, it is desirable to reduce a distance between the ferrite core and the blade by, e.g. arranging the sensing portion such that a tip end thereof protrudes toward the inside from the hole formed on the compressor housing as shown in FIG. 19 of JP-B-5645207. However, if the sensing portion is arranged in such a manner, the air flow inside the housing generated by high-speed rotation of the compressor wheel may be distorted and thus may adversely affect rotation of the compressor wheel.

On the other hand, if the eddy-current sensor is arranged such that the tip end of the sensing portion does not protrude toward the inside from the hole of the compressor housing and when the eddy-current sensor does not have sufficient sensitivity, it is not possible to accurately detect and count variations in the electric signal output from the eddy-current sensor, hence it is not possible to obtain the exact rotational speed of the compressor wheel.

It is an object of the invention to provide a turbocharger rotation detector that allows an improvement in detection accuracy of variation in electric signal caused by approach and recession of the blades of the compressor wheel.

According to an embodiment of the invention, a turbocharger rotation detector for detecting a rotational speed of a compressor wheel of a turbocharger, wherein the turbocharger comprises a turbine mounted on an exhaust gas path of a vehicle internal combustion engine and comprised of a turbine wheel rotationally driven by the exhaust gas from the internal combustion engine, and a compressor mounted on an air intake path of the internal combustion engine and comprised of the compressor wheel rotationally driven by rotation of the turbine wheel, comprises:

an oscillator circuit that comprises a coil generating a magnetic field inducing an eddy current in blades of the compressor wheel and outputs an AC signal as a detection signal, the AC signal having an amplitude varying with approach and recession of the blades;

a first detector circuit comprising a first integrator circuit for integrating, of the detection signal, a signal component that is of a positive voltage higher than a reference potential;

a second detector circuit comprising a second integrator circuit for integrating, of the detection signal, a signal component that is of a negative voltage lower than the reference potential;

a first interrupter circuit that passes, of an output signal of the first detector circuit, an AC component that varies in voltage with approach and recession of the blades and that interrupts a DC component;

a second interrupter circuit that passes, of an output signal of the second detector circuit, an AC component that varies in voltage with approach and recession of the blades and that interrupts a DC component; and

a differential amplifier circuit to which the signals passing through the first and second interrupter circuits are input.

### Effects of the Invention

According to an embodiment of the invention, a turbocharger rotation detector can be provided that allows an improvement in detection accuracy of variation in electric signal caused by approach and recession of the blades of the compressor wheel.

### BRIEF DESCRIPTION OF THE DRAWINGS

Next, the present invention will be explained in more detail in conjunction with appended drawings, wherein:

FIG. 1 is a schematic configuration diagram illustrating a turbocharger mounting a turbo rotation sensor in an embodiment;

FIG. 2 is a perspective view showing a compressor wheel of the turbocharger;

FIG. 3 is a cross sectional view showing a configuration example of an eddy-current sensor;

FIG. 4A is a schematic diagram illustrating a configuration example of a rotation detector;

FIG. 4B is a schematic diagram illustrating a configuration example of an oscillator circuit of the rotation detector;

FIG. 5 is a circuit diagram illustrating a configuration example of the main part of a signal processing circuit in the first embodiment;

FIG. 6A is a graph showing variation in voltages of first to fourth signal lines when the compressor wheel is rotating;

FIG. 6B is a graph showing waveform of output from the signal processing circuit 5 when electric potentials of the third and fourth signal lines S₃ and S₄ change as shown in the graph of FIG. 6A.

FIG. 7 is a circuit diagram illustrating a configuration example of a signal processing circuit in the second embodiment;

FIG. 8 is a circuit diagram illustrating a configuration example of a signal processing circuit in the third embodiment;

FIG. 9 is a circuit diagram illustrating a configuration example of a signal processing circuit in the fourth embodiment; and

FIG. 10 is a circuit diagram illustrating a configuration example of a differential amplifier circuit in the fifth embodiment.

### DETAILED DESCRIPTION OF THE PREFERRED EMBODIMENTS

### First Embodiment

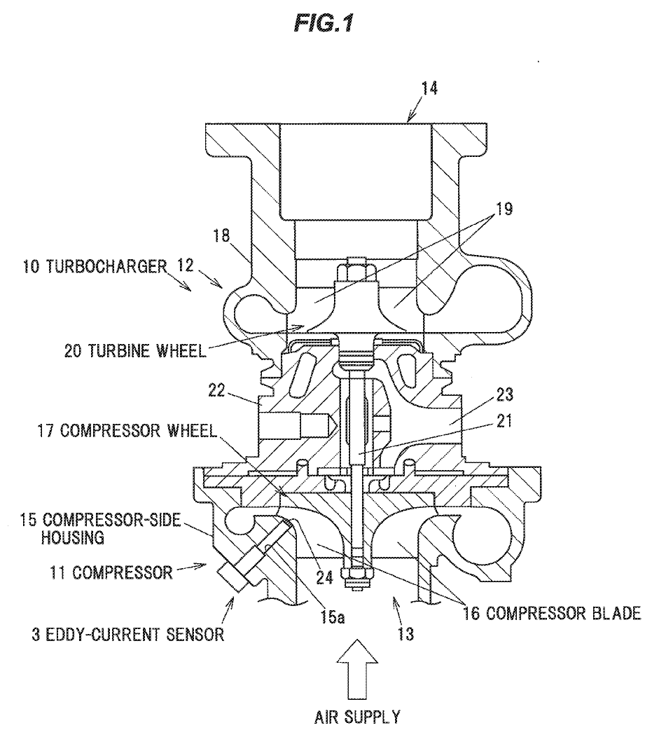

The first embodiment of the present invention will be described below in reference to FIGS. 1A to 6B.

General Configuration of Turbocharger

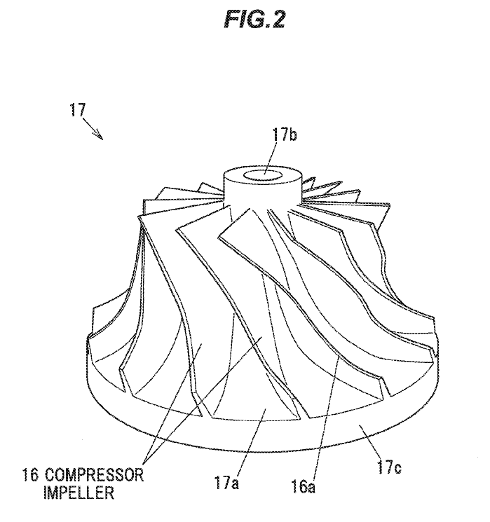

FIG. 1 is a schematic configuration diagram illustrating a turbocharger mounting a turbo rotation sensor in an embodiment. FIG. 2 is a perspective view showing a compressor wheel of the turbocharger.

As shown in FIG. 1, a turbocharger 10 has a compressor 11 provided on an air intake path 13 of a vehicle internal combustion engine (not shown), and a turbine 12 provided on an exhaust gas path 14 of the internal combustion engine.

The compressor 11 is composed of a compressor wheel 17 having plural compressor blades 16 and a compressor-side housing 15 housing the compressor wheel 17. Meanwhile, the turbine 12 is composed of a turbine wheel 20 having plural turbine blades 19 in a turbine-side housing 18 housing the turbine wheel 20. The turbine blades 19 receive exhaust gas from the internal combustion engine and the turbine wheel 20 thereby spins.

The compressor wheel 17 and the turbine wheel 20 are connected by a turboshaft 21, and the compressor wheel 17 is rotationally driven by rotation of the turbine wheel 20. Thus, in the turbocharger 10, the compressor wheel 17 rotates with rotation of the turbine wheel 20 which is rotationally driven by the exhaust gas from the internal combustion engine, and the intake air is thereby compressed and sent to the internal combustion engine.

The turboshaft 21 is rotatably supported by a bearing housing 22 which couples between the compressor-side housing 15 and the turbine-side housing 18. An oil passage 23, through which a lubricant for the turboshaft 21 and a cooling lubricating oil are supplied, is formed in the bearing housing 22, and the cooling effect of the lubricating oil supplied through the oil passage 23 prevents heat on the turbine 12 side from transferring to the compressor 11 side.

In the present embodiment, the compressor-side housing 15 and the compressor wheel 17 including the compressor blades 16 are formed of aluminum (or an aluminum alloy) which is an electrical conductor.

As shown in FIG. 2, the compressor wheel 17 is configured that a base 17a has a side surface curved such that a diameter gradually enlarges from the top end (the air inlet side, the upper side of the drawing) toward the base end (the turbine side, the lower side of the drawing) and the plural compressor blades 16 are integrally formed on the side surface of the base 17a so as to be inclined with respect to the axial direction. A through-hole 17b, through which the turboshaft 21 is inserted and integrally rotationally coupled, is formed at the center of the base 17a. The base 17a has a substantially disc-shaped base end portion 17c which extends on the base end side (the turbine side) with respect to the compressor blades 16. The compressor blades 16 are curved such that a diameter as a whole enlarges toward the base end, and each compressor blade 16 has a curved concave portion 16a on the outer periphery side.

An eddy-current sensor 3 for detecting rotation of the compressor wheel 17 is attached to the compressor-side housing 15. The eddy-current sensor 3 has a substantially columnar shape and is inserted into a through-hole 15a formed on the compressor-side housing 15. The through-hole 15a is provided to penetrate the compressor-side housing 15 from the outer surface to the inner surface, and opens at a position facing the concave portions 16a of the compressor blades 16. The eddy-current sensor 3 is inserted into the through-hole 15a from the outer surface side of the compressor-side housing 15.

An opening of the through-hole 15a located on the inner side and facing the compressor wheel 17 is closed with a resin cap 24. The cap 24 is fitted into the through-hole 15a without protruding toward the compressor wheel 17 beyond the end face of the opening of the through-hole 15a (the inner surface of the compressor-side housing 15 around the through-hole 15a). By closing the opening of the through-hole 15a with the cap 24, it is possible to prevent the air flow inside the compressor-side housing 15 generated by rotation of the compressor wheel 17 from being distorted.

Configuration of Rotation Detector

Next, a configuration of a rotation detector 1 for detecting rotation of the compressor wheel 17 of the turbocharger 10 will be described.

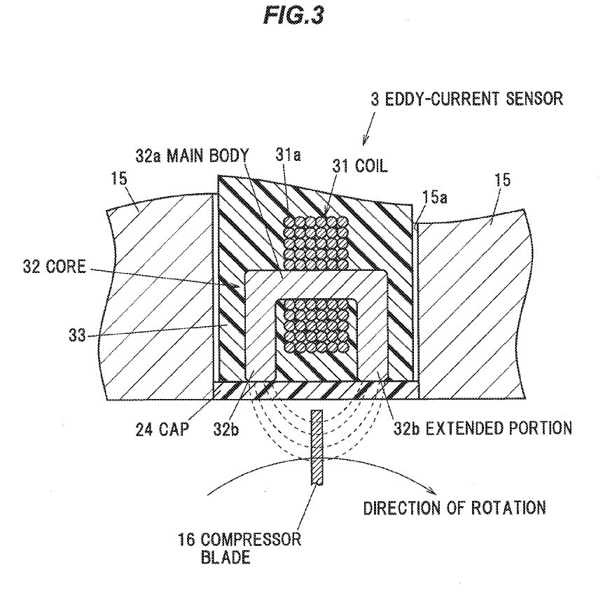

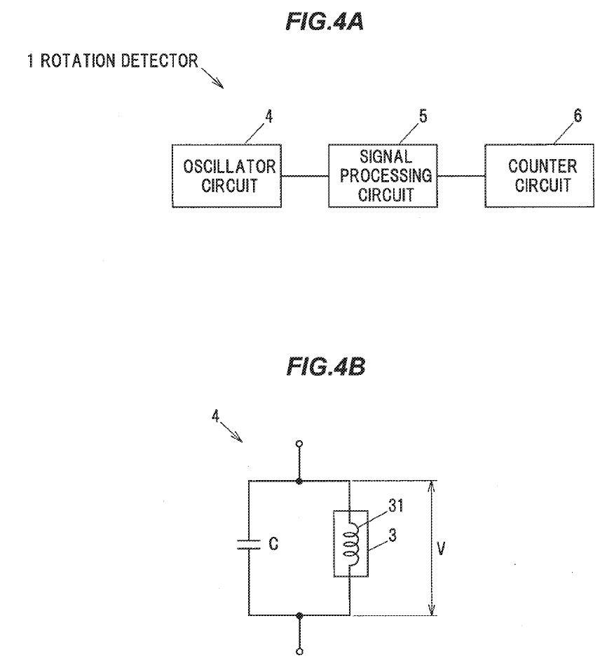

FIG. 3 is a cross sectional view showing a configuration example of the eddy-current sensor 3. FIG. 4A is a schematic diagram illustrating a configuration example of the rotation detector 1. FIG. 4B is a schematic diagram illustrating a configuration example of an oscillator circuit 4 of the rotation detector 1.

The rotation detector 1 is composed of the oscillator circuit 4 which includes the eddy-current sensor 3, a signal processing circuit 5 which converts a detection signal output from the oscillator circuit 4 into a signal at a frequency corresponding to a rotational speed of the compressor wheel 17, and a counter circuit 6 which detects the number of rotations of the compressor wheel 17 per hour by counting the frequency of the signal converted by the signal processing circuit 5.

A shown in FIG. 3, the eddy-current sensor 3 has a coil 31 formed by winding an enameled wire 31a, a core 32 inserted through the center of the coil 31, and a molded resin 33 covering the coil 31 and the core 32.

The core 32 is formed of a soft magnetic material such as ferrite, and has a U-shape formed by integrally providing a bar-shaped main body 32a with the enameled wire 31a wound therearound, and a pair of extended portions 32b vertically extending from both axial ends of the main body 32a. The core 32 is arranged such that the pair of extended portions 32b extend parallel to each other toward the cap 24.

The molded resin 33 is formed of, e.g., an insulating resin such as PPS (polyphenylene sulfide). The core 32 are arranged such that the tip ends of the pair of extended portions 32b are exposed from the molded resin 33 and face the cap 24. The cap 24 has, e.g. a disc shape having a thickness of 1 mm and is fixed to the inner surface of the through-hole 15a of the compressor-side housing 15 by, e.g. bonding. Two electric wires are respectively connected to both ends of the coil 31 and extend out of the molded resin 33, even though it is not illustrated.

The coil 31 generates a magnetic field which induces an eddy current in the compressor blades 16. The compressor blades 16 pass through a position at which the compressor blades 16 are affected by a magnetic field generated by an electric current flowing through the coil 31. In FIG. 3, magnetic field lines of this magnetic field are indicated by dashed lines. When the compressor blade 16 is located at the position facing the cap 24, an eddy-current loss occurs due to an eddy current induced in the compressor blade 16. In consequence, voltage of the detection signal output from the oscillator circuit 4 changes.

The oscillator circuit 4 has the coil 31 of the eddy-current sensor 3 and a resonance capacitor C connected in parallel to the coil 31, and oscillates when voltage is supplied from a power supply unit (not shown). Voltage V between two ends of the coil 31 is output as the detection signal to the signal processing circuit 5. This detection signal is a high-frequency signal having amplitude which decreases as the compressor blade 16 approaches the eddy-current sensor 3 and increases as the compressor blade 16 recedes.

A resonant frequency of the coil 31 and the resonance capacitor C is, e.g. 2 MHz and is a frequency high enough for a cycle at which the compressor blade 16 passes through the position facing the cap 24 due to rotation of the compressor wheel 17 (e.g. 10 kHz).

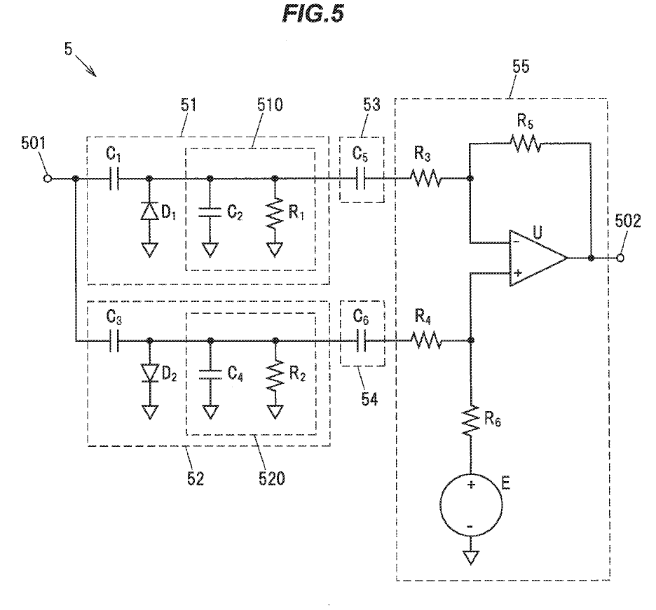

FIG. 5 is a circuit diagram illustrating a configuration example of the main part of the signal processing circuit 5 in the first embodiment.

The signal processing circuit 5 is configured that the detection signal of the oscillator circuit 4 is input to an input terminal 501 and a signal at a frequency corresponding to the rotational speed of the compressor wheel 17 is output from an output terminal 502.

The signal processing circuit 5 is provided with a first detector circuit 51 including a first integrator circuit 510 for integrating a signal component which is included in the detection signal of the oscillator circuit 4 and is a positive voltage higher than a reference potential, a second detector circuit 52 including a second integrator circuit 520 for integrating a signal component which is included in the detection signal of the oscillator circuit 4 and is a negative voltage lower than the reference potential, a first interrupter circuit 53 which passes an AC component, which is included in an output signal of the first detector circuit 51 and is voltage varying with approach and recession of the compressor blades 16, and interrupts a DC component of the output signal, a second interrupter circuit 54 that passes an AC component, which is included in an output signal of the second detector circuit 52 and is voltage varying with approach and recession of the blades, and interrupts a DC component of the output signal, and a differential amplifier circuit 55 to which the signals passing through the first and second interrupter circuits 53 and 54 are input.

In the circuit configuration example shown in FIG. 5, the first detector circuit 51 is composed of first and second capacitors C₁ and C₂, a first diode D₁, and a first resistor R₁. The first diode D₁, the second capacitor C₂ and the first resistor R₁ are connected in parallel between a first signal line S₁ and the reference potential. Of these three, the second capacitor C₂ and the first resistor R₁ constitute the first integrator circuit 510. In the first integrator circuit 510, the first resistor R₁ serves as a discharge resistor for discharging the electric charge stored in the second capacitor C₂.

The first capacitor C₁ is arranged such that one of a pair of electrodes is connected to the input terminal 501 and the other electrode is connected to the first signal line S₁. The first diode D₁ is arranged between the other electrode of the first capacitor C₁ and the reference potential, such that an anode is connected to the reference potential and a cathode is connected to the other electrode of the first capacitor C₁ via first signal line S₁.

The second detector circuit 52 is composed of third and fourth capacitors C₃ and C₄, a second diode D₂, and a second resistor R₂. The second diode D₂, the fourth capacitor C₄ and the second resistor R₂ are connected in parallel between a second signal line S₂ and the reference potential. Of these three, the fourth capacitor C₄ and the second resistor R₂ constitute the second integrator circuit 520. In the second integrator circuit 520, the second resistor R₂ serves as a discharge resistor for discharging the electric charge stored in the fourth capacitor C₄.

The third capacitor C₃ is arranged such that one of a pair of electrodes is connected to the input terminal 501 and the other electrode is connected to the second signal line S₂. The second diode D₂ is arranged between the other electrode of the third capacitor C₃ and the reference potential, such that an anode is connected to the reference potential and a cathode is connected to the other electrode of the third capacitor C₃ via second signal line S₂.

Meanwhile, in the circuit configuration example shown in FIG. 5, the first interrupter circuit 53 is constructed from a fifth capacitor C₅ and the second interrupter circuit 54 is constructed from a sixth capacitor C₆. The fifth capacitor C₅ is arranged such that one of a pair of electrodes is connected to the first signal line S₁ and the other electrode is connected to a third resistor R₃ of the differential amplifier circuit 55 (described later). Likewise, the sixth capacitor C₆ is arranged such that one of a pair of electrodes is connected to the second signal line S₂ and the other electrode is connected to a fourth resistor R₄ of the differential amplifier circuit 55 (described later).

The differential amplifier circuit 55 is composed of an op-amp U, the third resistor R₃ connected between an inverting input terminal of the op-amp U and the first interrupter circuit 53, the fourth resistor R₄ connected between a non-inverting input terminal of the op-amp U and the second interrupter circuit 54, a fifth resistor R₅ as a feedback resistor connected between an output terminal and the inverting input terminal of the op-amp U, a bias voltage source E, and a sixth resistor R₆ connected between the bias voltage source E and the non-inverting input terminal of the op-amp U. The inverting input terminal and non-inverting input terminal of the op-amp U respectively correspond to the first input terminal and the second input terminal of the invention. Output voltage of the bias voltage source E is half the source voltage (e.g., 5V) supplied to the op-amp U and is, e.g., 2.5V.

The signal processing circuit 5 is configured that output voltage of the op-amp U is output from the output terminal 502. The fifth capacitor C₅ is connected to the third resistor R₃ of the signal processing circuit 5 through a third signal line S₃. The sixth capacitor C₆ is connected to the fourth resistor R₄ of the signal processing circuit 5 through a fourth signal line S₄.

Here, capacitance of the first and third capacitors C₁ and C₃ is, e.g. 100 pF, capacitance of the second and fourth capacitors C₂ and C₄ is, e.g. 40 pF, and capacitance of the fifth and sixth capacitors C₅ and C₆ is, e.g. 0.1 nF. Then, the resistance value of the first and second resistors R₁ and R₂ is, e.g. 100 kΩ, the resistance value of the third and fourth resistors R₃ and R₄ is, e.g. 10 kΩ, and the resistance value of the fifth and sixth resistors R₅ and R₆ is, e.g. 100 kΩ.

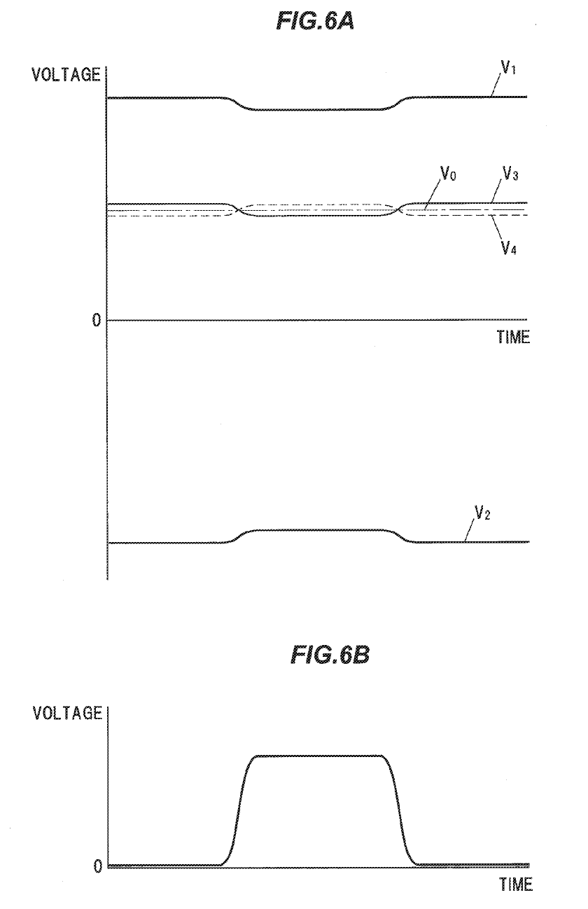

FIG. 6A is a graph showing variation in voltages V₁ to V₄ of the first to fourth signal lines S₁ to S₄ when the compressor wheel 17 is rotating. In FIG. 6A, the voltages V₁ to V₃ of the first to third signal lines S to S₃ are indicated by solid lines, and the voltage V₄ of the fourth signal line S₄ is indicated by a dashed line. FIG. 6A also shows a dot-and-dash line which indicates bias voltage V₀ applied by the bias voltage source E. FIG. 6B is a waveform of output from the signal processing circuit 5 when electric potentials of the third and fourth signal lines S₃ and S₄ change as shown in the graph of FIG. 6A. FIGS. 6A and 6B show the graphs where one of the compressor blades 16 approaches the eddy-current sensor 3 in the middle of the time axis shown as the horizontal axis.

Since the cathode of the first diode D₁ is connected to the first signal line S₁, the detection signal of the oscillator circuit 4 input to the input terminal 501 of the signal processing circuit 5 is offset to the positive voltage side, passes through the first capacitor C₁, and is integrated by the first integrator circuit 510. In other words, the first detector circuit 51 detects the detection signal of the oscillator circuit 4 on the positive voltage side.

Meanwhile, since the anode of the second diode D₂ is connected to the second signal line S₂, the detection signal of the oscillator circuit 4 input to the input terminal 501 of the signal processing circuit is offset to the negative voltage side, passes through the third capacitor C₃, and is integrated by the second integrator circuit 520. In other words, the second detector circuit 52 detects the detection signal of the oscillator circuit 4 on the negative voltage side.

Since the detection signal output from the oscillator circuit 4 is a high-frequency signal having an amplitude which decreases as the compressor blade 16 approaches the eddy-current sensor 3 and increases as the compressor blade 16 recedes as described previously, the voltage V₁ of the first signal line S₁ corresponding to the output signal of the first integrator circuit 510 is on the positive side with respect to the reference potential, and decreases as the compressor blade 16 approaches the eddy-current sensor 3 and increases as the compressor blade 16 recedes from the eddy-current sensor 3. Meanwhile, the voltage V₂ of the second signal line S₂ corresponding to the output signal of the second integrator circuit 520 is on the negative side with respect to the reference potential, and has an absolute value which decreases as the compressor blade 16 approaches the eddy-current sensor 3 and increases as the compressor blade 16 recedes from the eddy-current sensor 3.

In the op-amp U, electric potentials of the non-inverting input terminal and the inverting input terminal virtually short-circuited thereto are biased by the bias voltage source E. Meanwhile, the first interrupter circuit 53 constructed from the fifth capacitor C₅ passes an AC component which is included in the voltage V₁ of the first signal line S₁ and varies with approach and recession of the compressor blade 16, and the second interrupter circuit 54 constructed from the sixth capacitor C₆ passes an AC component which is included in the voltage V₂ of the second signal line S₂ and varies with approach and recession of the compressor blade 16. Thus, the voltage V₃ of the third signal line S₃ varies in accordance with amplitude variation of the voltage V₁ of the first signal line S₁ while swinging above and below the bias voltage V₀. Likewise, the voltage V₄ of the fourth signal line S₄ varies in accordance with amplitude variation of the voltage V₂ of the second signal line S₂ while swinging above and below the bias voltage V₀.

In the differential amplifier circuit 55, an electric potential difference between the voltage V₃ of the third signal line S₃ and the voltage V₄ of the fourth signal line S₄ is amplified with an amplification factor according to the resistance values of the third and fifth resistors R₃ and R₅ and is then output as the output signal of the signal processing circuit 5. This output signal waveform is a waveform in which an increase in voltage during approach of the compressor blade 16 forms a square wave, as shown in FIG. 6B.

The counter circuit 6 converts (binarizes) the output signal of the signal processing circuit 5 by using a binarization circuit such as comparator and dividing the frequency of the binarized pulse signal, e.g., such that one pulse is output per rotation of the compressor wheel 17. The number of rotations of the compressor wheel 17 per hour is obtained by counting the pulses.

### Effects of the First Embodiment

In the first embodiment, the signal processing circuit 5 has the first detector circuit 51 detecting the detection signal of the oscillator circuit 4 on the positive voltage side and the second detector circuit 52 detecting the detection signal of the oscillator circuit 4 on the negative voltage side, and a difference between the AC components of the outputs signals of the first and second detector circuits 51 and 52, which are the components varying with approach and recession of the compressor blades 16, is amplified by the differential amplifier circuit 55 and is then output to the counter circuit 6. Therefore, as compared to when, e.g., the second detector circuit 52 is not provided, it is possible to increase sensitivity to variation in the detection signal output from the oscillator circuit 4, and the number of rotations of the compressor wheel 17 thus can be detected more precisely.

In addition, since sensitivity is increased as described above, the number of times that the compressor blade 16 passes through the portion facing the opening of the through-hole 15a can be counted without missing any single pass even when a distance between the core 32 of the eddy-current sensor 3 and the compressor blade 16 is increased by closing the opening of the through-hole 15a with the cap 24. Thus, it is possible to obtain the exact number of rotations of the compressor wheel 17 while preventing the air flow inside the compressor-side housing 15 from being distorted.

Furthermore, among the high-frequency signals input to the input terminal 501 of the signal processing circuit 5, the high-frequency signal passing through the first detector circuit 51 and the first interrupter circuit 53 and the high-frequency signal passing through the second detector circuit 52 and the second interrupter circuit 54 cancel out each other in the differential amplifier circuit 55. Therefore, the high-frequency component in the signal output from the differential amplifier circuit 55 can be reduced.

### Second Embodiment

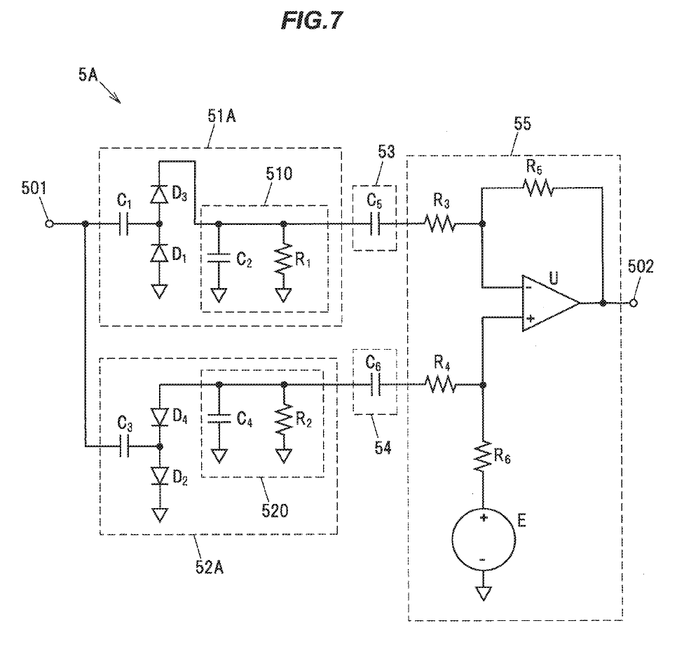

Next, the second embodiment of the invention will be described in reference to FIG. 7. In the second embodiment, a signal processing circuit 5A which converts the detection signal output from the oscillator circuit 4 into a signal at a frequency corresponding to the rotational speed of the compressor wheel 17 has a configuration different from the signal processing circuit 5 in the first embodiment.

FIG. 7 is a circuit diagram illustrating a configuration example of the signal processing circuit 5A in the second embodiment. The same constituent elements as those of the signal processing circuit 5 in the first embodiment are denoted by the same reference numerals as those in FIG. 4 and the overlapping explanation thereof will be omitted.

The signal processing circuit 5A in the second embodiment has a first detector circuit 51A which detects the detection signal of the oscillator circuit 4 on the positive voltage side and a second detector circuit 52A which detects the detection signal of the oscillator circuit 4 on the negative voltage side. The first detector circuit 51A is obtained by adding a third diode D₃ to the first detector circuit 51 in the first embodiment. Likewise, the second detector circuit 52A is obtained by adding a fourth diode D₄ to the second detector circuit 52 in the first embodiment.

The third diode D₃ is connected between the cathode of the first diode D₁ and the first integrator circuit 510 such that a cathode thereof is located on the first integrator circuit 510 side. An anode of the third diode D₃ is connected to the cathode of the first diode D₁. The fourth diode D₄ is connected between the anode of the second diode D₂ and the second integrator circuit 520 such that an anode thereof is located on the second integrator circuit 520 side. A cathode of the fourth diode D₄ is connected to the anode of the second diode D₂.

According to the second embodiment, in addition to the effects of the first embodiment, the electric charge stored in the second capacitor C₂ of the first integrator circuit 510 is less likely to be released toward the first capacitor C₁ due to the presence of the third diode D₃. Likewise, the electric charge stored in the fourth capacitor C₄ of the second integrator circuit 520 is less likely to be released toward the third capacitor C₃ due to the presence of the fourth diode D₄. Thus, it is possible to further increase sensitivity to variation in the detection signal output from the oscillator circuit 4.

### Third Embodiment

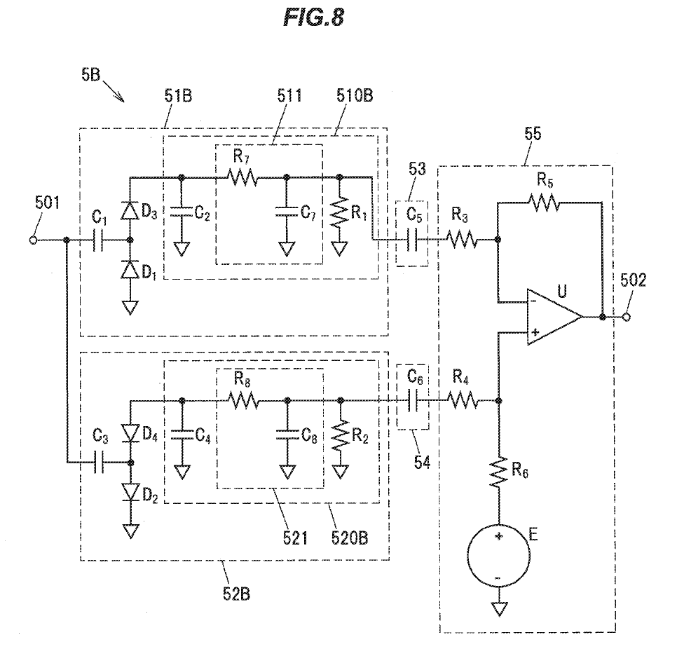

Next, the third embodiment of the invention will be described in reference to FIG. 8. A signal processing circuit 5B in the third embodiment is obtained by further adding first and second low-pass filter circuits 511 and 521 to the signal processing circuit 5A in the second embodiment. The same constituent elements as those of the signal processing circuit 5A are denoted by the same reference numerals as those in FIG. 7 and the overlapping explanation thereof will be omitted.

The signal processing circuit 5B in the third embodiment has the first low-pass filter circuit 511 in an integrator circuit 510B of a first detector circuit 51B and the second low-pass filter circuit 521 in an integrator circuit 520B in a second detector circuit 52B.

The first low-pass filter circuit 511 is arranged between the second capacitor C₂ and the first resistor R₁ of the integrator circuit 510B and is composed of a seventh resistor R₇ and a seventh capacitor C₇. The seventh capacitor C₇ is connected in parallel to the first resistor R₁ and is located on the first interrupter circuit 53 side with respect to the seventh resistor R₇.

The second low-pass filter circuit 521 is arranged between the fourth capacitor C₄ and the second resistor R₂ of the integrator circuit 520B and is composed of an eighth resistor R₈ and an eighth capacitor C₈. The eighth capacitor C₈ is connected in parallel to the second resistor R₂ and is located on the second interrupter circuit 54 side with respect to the eighth capacitor C₈. The resistance value of the seventh and eighth resistors R₇ and R₈ is, e.g. 5 kΩ, and capacitance of the seventh and eighth capacitors C₇ and C₈ is, e.g. 4 pF.

According to the third embodiment, in addition to the effects of the second embodiment, it is possible to reduce a component with a resonant frequency of the oscillator circuit 4 in a signal output from the first detector circuit 51B to the first interrupter circuit 53 and in a signal output from the second detector circuit 52B to the second interrupter circuit 54, and an unwanted high-frequency component in the output signal of the signal processing circuit 5B can be reduced.

### Fourth Embodiment

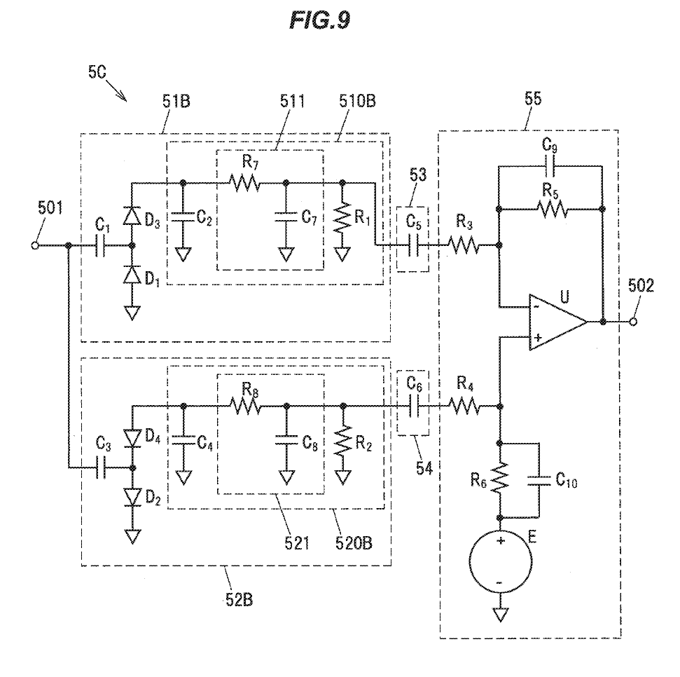

Next, the fourth embodiment of the invention will be described in reference to FIG. 9. A signal processing circuit SC in the fourth embodiment is obtained by further adding ninth and tenth capacitors C₉ and C₁₀ to the signal processing circuit 5B in the third embodiment. The same constituent elements as those of the signal processing circuit 5B are denoted by the same reference numerals as those in FIG. 8 and the overlapping explanation thereof will be omitted.

The ninth capacitor C₉ is connected in parallel to the fifth resistor R₅. The tenth capacitor C₁₀ is connected in parallel to the sixth resistor R₆. The ninth and tenth capacitors C₉ and C₁₀ have the same capacitance which is, e.g. 10 pF.

According to the fourth embodiment, in addition to the effects of the third embodiment, an unwanted high-frequency component in the output signal of the signal processing circuit SC can be further reduced since the ninth and tenth capacitors C₉ and C₁₀ absorb the high-frequency signal and provide signal smoothing.

### Fifth Embodiment

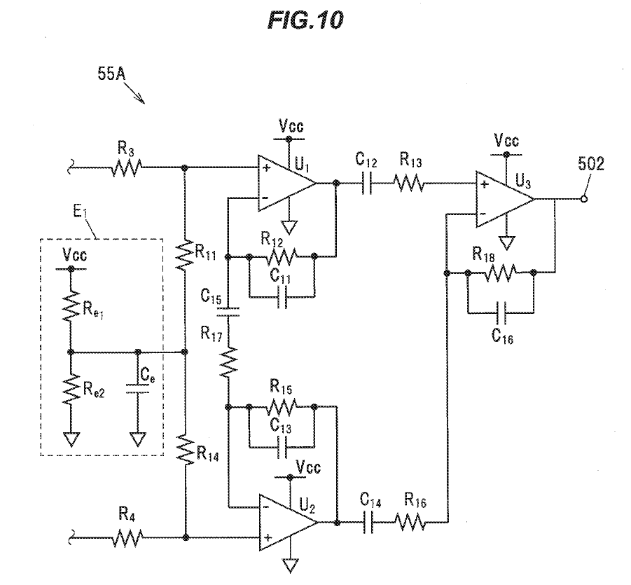

Next, the fifth embodiment of the invention will be described in reference to FIG. 10. In the fifth embodiment, a differential amplifier circuit 55A shown in FIG. 10 is used in place of the differential amplifier circuit 55 in the first to fourth embodiments.

The differential amplifier circuit 55A is composed of first to third op-amps U₁ to U₃, a bias voltage source E₁, the third and fourth resistors R₃ and R₄, eleventh to eighteenth resistors R₁₁ to R₁₈, and eleventh to sixteenth capacitors C₁₁ to C₁₆. The first op-amp U₁ amplifies a high-frequency signal passing through the first interrupter circuit 53, and the second op-amp U₂ amplifies a high-frequency signal passing through the second interrupter circuit 54. The third op-amp U₃ further amplifies a difference between the signal amplified by the first op-amp U₁ and the signal amplified by the second op-amp U₂. Source voltage Vcc supplied to the first to third op-amps U₁ to U₃ is the same (e.g., 5V).

Bias voltage, which is output voltage of the bias voltage source E₁, is connected to a non-inverting input terminal of the first op-amp U₁ via the eleventh resistor R₁₁. Likewise, bias voltage output from the bias voltage source E₁ is connected to a non-inverting input terminal of the second op-amp U₂ via the fourteenth resistor R₁₄. The bias voltage source E₁ generates bias voltage by resistive division using the source voltage Vcc of the op-amps. In other words, one bias voltage source E₁ is connected to respective non-inverting input terminals of the first and second op-amps U₁ and U₂ via the resistors (the eleventh resistor R₁₁ and the fourteenth resistor R₁₄).

The bias voltage source E₁ is composed of a pair of resistors Re₁ and Re₂ for resistive division of the source voltage Vcc of the first to third op-amps U₁ to U₃, and a smoothing capacitor Ce. The pair of resistors Re₁ and Re₂ have the same resistance value and divides the source voltage Vcc, hence, half the voltage is output as bias voltage. The capacitor Ce is connected between the pair of resistors Re₁ and Re₂. However, the capacitor Ce may be omitted.

The fifteenth capacitor C₁₅ and the seventeenth resistor R₁₇ are connected in series between the inverting input terminal of the first op-amp U₁ and the inverting input terminal of the second op-amp U₂. The eleventh capacitor C₁₁ is connected in parallel to the twelfth resistor R₁₂ which is negative feedback resistance of the first op-amp U₁. Likewise, the thirteenth capacitor C₁₃ is connected in parallel to the fifteenth resistor R₁₅ which is negative feedback resistance of the second op-amp U₂.

The twelfth capacitor C₁₂ and the thirteenth resistor R₁₃ are connected in series between the output terminal of the first op-amp U₁ and the non-inverting input terminal of the third op-amp U₃. The fourteenth capacitor C₁₄ and the sixteenth resistor R₁₆ are connected in series between the output terminal of the second op-amp U₂ and the inverting input terminal of the third op-amp U₃.

The sixteenth capacitor C₁₆ is connected in parallel to the eighteenth resistor R₁₈ which is negative feedback resistance of the third op-amp U₃. The output terminal of the third op-amp U₃ is connected to the output terminal 502.

The resistance value of the eleventh and fourteenth resistors R₁₁ and R₁₄ is, e.g. 500 kΩ. The resistance value of the twelfth and fifteenth resistors R₁₂ and R₁₅ is, e.g. 100 kΩ. Capacitance of the eleventh and thirteenth capacitors C₁₁ and C₁₃ is, e.g. 10 pF. Capacitance of the fifteenth capacitor C₁₅ is, e.g. 0.1 nF. The resistance value of the seventeenth resistor R₁₇ is, e.g. 10 kΩ. Capacitance of the twelfth and fourteenth capacitors C₁₂ and C₁₄ is, e.g. 0.1 nF. The resistance value of the thirteenth and sixteenth resistors R₁₃ and R₁₆ is, e.g. 10 kΩ. The resistance value of the eighteenth resistor R₁₈ is, e.g. 100 kΩ. Capacitance of the sixteenth capacitor C₁₆ is, e.g. 10 pF.

In the fifth embodiment, since the bias voltage source E₁ generates bias voltage by resistive division using the source voltage Vcc of the op-amps, the output signal output from the output terminal 502 is less affected by noise of source voltage via bias voltage source, as compared to the configurations of the first to fourth embodiments. In addition, since one bias voltage source E₁ is connected to the respective non-inverting input terminals of the first and second op-amps U₁ and U₂, the circuit configuration can be simplified.

### SUMMARY OF THE EMBODIMENTS

Technical ideas understood from the embodiments will be described below citing the reference numerals, etc., used for the embodiments. However, each reference numeral described below is not intended to limit the constituent elements in the claims to the members, etc., specifically described in the embodiments.

[1] A turbocharger rotation detector (1) for detecting a rotational speed of a compressor wheel (17) of a turbocharger (10) that comprises a turbine (12) provided on an exhaust gas path (14) of a vehicle internal combustion engine and comprising a turbine wheel (20) rotationally driven by the exhaust gas from the internal combustion engine and a compressor (11) provided on an air intake path (13) of the internal combustion engine and comprising the compressor wheel (17) rotationally driven by rotation of the turbine wheel (20), the turbocharger rotation detector (1) comprising: an oscillator circuit (4) that comprises a coil (31) generating a magnetic field inducing an eddy current in blades (compressor blades 16) of the compressor wheel (17) and outputs an AC signal as a detection signal, the AC signal having an amplitude varying with approach and recession of the blades (16); a first detector circuit (51) comprising a first integrator circuit (510) for integrating a signal component that is included in the detection signal and is a positive voltage higher than a reference potential; a second detector circuit (52) comprising a second integrator circuit (520) for integrating a signal component that is included the detection signal and is a negative voltage lower than the reference potential; a first interrupter circuit (53) that passes an AC component, that is included in an output signal of the first detector circuit (51) and is voltage varying with approach and recession of the blades (16), and interrupts a DC component of the output signal; a second interrupter circuit (54) that passes an AC component, that is included in an output signal of the second detector circuit (52) and is voltage varying with approach and recession of the blades (16), and interrupts a DC component of the output signal; and a differential amplifier circuit (55) to which the signals passing through the first and second interrupter circuits (53, 54) are input.

[2] The turbocharger rotation detector (1) defined by [1], wherein the first detector circuit (51) comprises a first capacitor (C₁) receiving the detection signal through one of a pair of electrodes and a first diode (D₁) arranged between the other electrode of the first capacitor (C₁) and the reference potential, the second detector circuit (52) comprises a second capacitor (C₂) receiving the detection signal through one of a pair of electrodes and a second diode (D₂) arranged between the other electrode of the second capacitor (C₂) and the reference potential, the first diode (D₁) is arranged such that an anode is connected to the reference potential and a cathode is connected to the other electrode of the first capacitor (C₁), and the second diode (D₂) is arranged such that an anode is connected to the other electrode of the second capacitor (C₂) and a cathode is connected to the reference potential.

[3] The turbocharger rotation detector (1) defined by [2], wherein the first detector circuit (51) comprises a third diode (D₃) between the cathode of the first diode (D₁) and the first integrator circuit (510), the third diode (D₃) comprising a cathode on the first integrator circuit (510) side, and the second detector circuit (52) comprises a fourth diode (D₄) between the anode of the second diode (D₂) and the second integrator circuit (520), the fourth diode (D₄) comprising an anode on the second integrator circuit (520) side.

[4] The turbocharger rotation detector (1) defined by any one of [1] to [3], wherein the first detector circuit (51) further comprises a first low-pass filter circuit (511), and the second detector circuit (52) further comprises a second low-pass filter circuit (521).

[5] The turbocharger rotation detector (1) defined by any one of [1] to [4], wherein the differential amplifier circuit (55) comprises an operational amplifier (U) comprising first and second input terminals, a bias voltage source (E) for biasing voltage of the first and second input terminals, resistors (R₃, R₄) respectively provided between the first interrupter circuit (53) and the first input terminal and between the second interrupter circuit (54) and the second input terminal, and a feedback resistor (R₅) provided between an output terminal and the first input terminal of the operational amplifier (U).

[6] The turbocharger rotation detector (1) defined by [5], wherein capacitors (C₉, C₁₀) are connected respectively in parallel with the feedback resistor (R₅) and a resistor provided between the bias voltage source (E) and the second input terminal.

[7] The turbocharger rotation detector (1) defined by any one of [1] to [4], wherein the differential amplifier circuit (55A) comprises at least not less than two operational amplifiers (U₁, U₂), and one bias voltage source (E₁) is connected to respective non-inverting input terminals of the not less than two operational amplifiers (U₁, U₂) via resistors (R₁₁, R₁₄).

[8] The turbocharger rotation detector (1) defined by any one of [1] to [4], wherein the differential amplifier circuit (55A) comprises at least not less than two operational amplifiers (U₁, U₂), a bias voltage source is connected to respective non-inverting input terminals of the not less than two operational amplifiers via resistors, and the bias voltage source generates bias voltage by resistive division using source voltage of the operational amplifiers.

Although the embodiments of the invention have been described, the invention according to claims is not to be limited to the embodiments. Further, it should be noted that all combinations of the features described in the embodiments are not necessary to solve the problem of the invention.

What is claimed is:

1. A turbocharger rotation detector for detecting a rotational speed of a compressor wheel of a turbocharger, wherein the turbocharger comprises a turbine mounted on an exhaust gas path of a vehicle internal combustion engine and comprised of a turbine wheel rotationally driven by the exhaust gas from the internal combustion engine, and a compressor mounted on an air intake path of the internal combustion engine and comprised of the compressor wheel rotationally driven by rotation of the turbine wheel, the turbocharger rotation detector comprising:
an oscillator circuit that comprises a coil generating a magnetic field inducing an eddy current in blades of the compressor wheel and outputs an AC signal as a detection signal, the AC signal having an amplitude varying with approach and recession of the blades;
a first detector circuit comprising a first integrator circuit for integrating, of the detection signal, a signal component that is of a positive voltage higher than a reference potential;
a second detector circuit comprising a second integrator circuit for integrating, of the detection signal, a signal component that is of a negative voltage lower than the reference potential;
a first interrupter circuit that passes, of an output signal of the first detector circuit, an AC component that varies in voltage with approach and recession of the blades and that interrupts a DC component;
a second interrupter circuit that passes, of an output signal of the second detector circuit, an AC component that varies in voltage with approach and recession of the blades and that interrupts a DC component; and
a differential amplifier circuit to which the signals passing through the first and second interrupter circuits are input.

2. The turbocharger rotation detector according to claim 1, wherein the first detector circuit comprises a first capacitor receiving the detection signal through one of a pair of electrodes and a first diode arranged between the other electrode of the first capacitor and the reference potential,
wherein the second detector circuit comprises a second capacitor receiving the detection signal through one of a pair of electrodes and a second diode arranged between the other electrode of the second capacitor and the reference potential,
wherein the first diode is arranged such that an anode is connected to the reference potential and a cathode is connected to the other electrode of the first capacitor, and
wherein the second diode is arranged such that an anode is connected to the other electrode of the second capacitor and a cathode is connected to the reference potential.

3. The turbocharger rotation detector according to claim 2, wherein the first detector circuit comprises a third diode between the cathode of the first diode and the first integrator circuit, the third diode comprising a cathode on the first integrator circuit side, and
wherein the second detector circuit comprises a fourth diode between the anode of the second diode and the second integrator circuit, the fourth diode comprising an anode on the second integrator circuit side.

4. The turbocharger rotation detector according to claim 1, wherein the first detector circuit further comprises a first low-pass filter circuit, and
wherein the second detector circuit further comprises a second low-pass filter circuit.

5. The turbocharger rotation detector according to claim 1, wherein the differential amplifier circuit comprises an operational amplifier comprising first and second input terminals, a bias voltage source for biasing voltage of the first and second input terminals, resistors respectively provided between the first interrupter circuit and the first input terminal and between the second interrupter circuit and the second input terminal, and a feedback resistor provided between an output terminal and the first input terminal of the operational amplifier.

6. The turbocharger rotation detector according to claim 5, wherein capacitors are connected respectively in parallel with the feedback resistor and a resistor provided between the bias voltage source and the second input terminal.

7. The turbocharger rotation detector according to claim 1, wherein the differential amplifier circuit comprises at least not less than two operational amplifiers, and one bias voltage source is connected to respective non-inverting input terminals of the not less than two operational amplifiers via resistors.

8. The turbocharger rotation detector according to claim 1, wherein the differential amplifier circuit comprises at least not less than two operational amplifiers, a bias voltage source is connected to respective non-inverting input terminals of the not less than two operational amplifiers via resistors, and the bias voltage source generates bias voltage by resistive division of source voltage using the operational amplifiers.
